(19) United States
(12) Patent Application Publication
(10) Pub. No.: US 2007/0092035 A1
(43) Pub. Date: Apr. 26, 2007

(54) Method of compensating for the frequency error of system clock in mobile communication terminal with digitally controlled crystal oscillator and mobile communication terminal thereof

(75) Inventor: Chang Seok Kim, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/583,042

(22) Filed: Oct. 19, 2006

(30) Foreign Application Priority Data
Oct. 26, 2005 (KR) 10-2005-0101215

(51) Int. Cl. H04L 25/03

(52) U.S. Cl. 375/296

(57) ABSTRACT

A method of compensating a frequency error of a system clock, comprising: detecting an ambient temperature, providing the frequency compensation value for compensating the frequency error of the system clock which is generated in a digitally controlled crystal oscillator on the basis of the detected ambient temperature, and controlling the frequency error of the system clock generated in the digitally controlled crystal oscillator to compensate for the frequency error in accordance with the frequency compensation value.

The present application claims priority from Korean Patent Application No. 10-2005-0101215, filed on Oct. 26, 2005, the disclosure of which is incorporated herein by reference.

### BACKGROUND OF THE INVENTION

1. Field of the Invention

The present invention relates to a method of compensating for the frequency error of a system clock in a mobile communication terminal with a digitally controlled crystal oscillator and the mobile communication terminal thereof.

2. Description of the Related Art

Demand for mobile communication terminals has increased rapidly. In these mobile communication terminals, it was important that one of the components of the terminal was a small crystal oscillator with a high precision to generate a system clock.

Conventional mobile communication terminals have used a temperature compensating crystal oscillator (TCXO) for generating a system clock and for compensating for frequency errors of a system clock. The temperature compensating crystal oscillator, which is classified as either an analog type or a digital type, compensated for a frequency change according to an ambient temperature change.

However, there is a tendency for manufacturers of mobile communication terminals for GSM to use a digital controlled crystal oscillator because the digital controlled crystal oscillator is less expensive than a temperature compensating crystal oscillator.

When a connection state between a mobile communication terminal and a network is adequate, a mobile communication terminal measures a frequency error of the RF signals received from a base station and compensates for the frequency error of a system clock on the basis of the measured frequency error.

When a connection state between a mobile communication terminal with a DCXO and a network is not adequate, the mobile communication terminal with a DCXO does not compensate for the frequency error of the system clock according to a temperature change.

### SUMMARY OF THE INVENTION

Accordingly, an aspect of the present invention is to provide a mobile communication terminal, comprising a digitally controlled crystal oscillator for generating a system clock; a sensor for detecting an ambient temperature; a frequency compensation value provider for providing a frequency compensation value for compensating for a frequency error in the system clock generated in the digitally controlled crystal oscillator on the basis of the ambient temperature detected from the sensor; and a controller for transmitting a control signal for compensating for a frequency error of a system clock to the digitally controlled crystal oscillator on the basis of the frequency compensation value provided from the frequency compensation value provider, and for controlling the frequency of the system clock generated from the digitally controlled crystal oscillator.

The mobile communication terminal further comprises a memory unit which stores a program for executing a frequency compensation value calculation function to calculate the frequency compensation value, wherein the frequency compensation value provider calculates the frequency compensation value of the system clock using the program when an ambient temperature is input from the sensor.

The program calculates a frequency compensation value using a Taylor series as described below:

$$f ( freq ) = f ( a ) + {f}^{′} ( a ) ( T - a ) + ( \frac{{f}^{2} ( a )}{2 !} ) {( T - a )}^{2} + ( \frac{{f}^{3} ( a )}{3 !} ) {( T - a )}^{3} + … + ( \frac{{f}^{n} ( a )}{n !} ) {( T - a )}^{n} + …$$

f(freq) is a frequency compensation value, “T” is an ambient temperature detected by a temperature sensor, and “a” is a coefficient according to a characteristic of a DCXO.

The mobile communication terminal further comprises a memory unit which stores an ambient temperature and a frequency compensation value of a system clock respectively corresponding to the ambient temperature in the form of a look up table, wherein the frequency compensation value provider reads a frequency compensation value of the system clock corresponding to the ambient temperature by searching the look up table when an ambient temperature is input from the sensor, and outputs the frequency compensation value to controller.

The mobile communication terminal further comprises a memory unit which stores a difference between an ambient temperature and predetermined reference temperature, and a frequency compensation value of a system clock respectively corresponding to the difference in the form of a look up table, wherein the frequency compensation value provider calculates a difference between an ambient temperature and a predetermined reference temperature, reads the frequency compensation value of the system clock corresponding to the difference by searching the lookup table, and outputs the frequency compensation value to the controller.

An aspect of the present invention is to provide a method of compensating a frequency error of a system clock, comprising: detecting an ambient temperature; providing the frequency compensation value for compensating the frequency error of the system clock which is generated in a digitally controlled crystal oscillator on the basis of the detected ambient temperature; and controlling the frequency error of the system clock generated in the digitally controlled crystal oscillator to compensate for the frequency error in accordance with the frequency compensation value.

The method further comprises the step of storing a program for executing the frequency compensation value calculation function to calculate the frequency compensation value of the system clock corresponding to the ambient temperature, wherein the frequency compensation value of the system clock is calculated using the program when the ambient temperature is input.

The program calculates a frequency compensation value using a Taylor series as described below:

$$f ( freq ) = f ( a ) + {f}^{′} ( a ) ( T - a ) + ( \frac{{f}^{2} ( a )}{2 !} ) {( T - a )}^{2} + ( \frac{{f}^{3} ( a )}{3 !} ) {( T - a )}^{3} + … + ( \frac{{f}^{n} ( a )}{n !} ) {( T - a )}^{n} + …$$

f(freq) is a frequency compensation value, “T” is an ambient temperature detected by a temperature sensor, and “a” is a coefficient according to a characteristic of a DCXO.

The method further comprises the step of storing the ambient temperature and the frequency compensation value of the system clock respectively corresponding to the ambient temperature in the form of lookup table, wherein the frequency compensation value of the system clock corresponding to the ambient temperature is obtained using a lookup table search when the ambient temperature is input.

The method further comprises the step of storing a difference between an ambient temperature and a predetermined reference temperature and the frequency compensation value of the system clock respectively corresponding to the difference in the form of a lookup table, wherein the difference between the ambient temperature and the predetermined reference temperature is calculated when the ambient temperature is input, and the frequency compensation value of the system clock corresponding to the difference is obtained using a lookup table search.

### BRIEF DESCRIPTION OF THE DRAWINGS

The above aspects of the present invention will be more apparent by describing certain exemplary embodiments of the present invention with reference to the accompanying drawings, in which:

FIG. 1 is a block diagram of a mobile communication terminal according to an embodiment of the present invention, and

FIG. 2 is a flow chart providing an explanation of a method for compensating for the frequency error of a system clock in mobile communication terminal with a digitally controlled crystal oscillator according to an embodiment of the present invention.

### DETAILED DESCRIPTION OF THE EMBODIMENTS

Exemplary embodiments of the present invention will be described herein below with reference to the accompanying drawings.

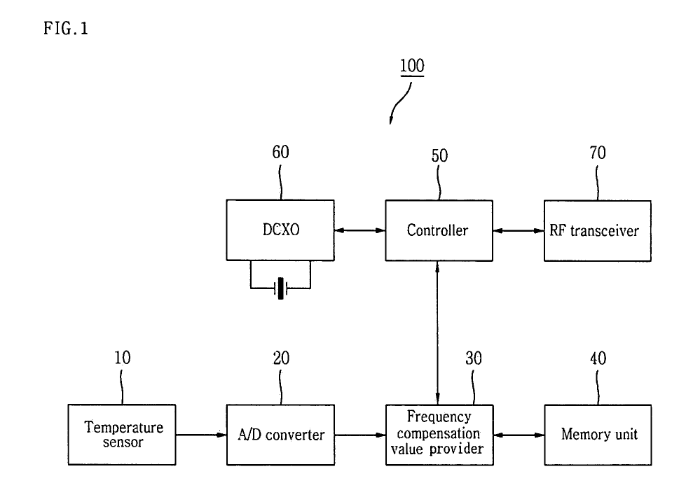

FIG. 1 is a block diagram of a mobile communication terminal according to an embodiment of the present invention.

Referring to FIG. 1, this mobile communication terminal 100 comprises a temperature sensor 10, an analog to digital converter 20, a frequency compensation value provider 30, a memory unit 40, a controller 50, a digitally controlled crystal oscillator 60 and a wireless transceiver 70.

A temperature sensor 10 detects an ambient temperature of a mobile communication terminal 100 and outputs the detected ambient temperature to an A/D converter 20 in the form of an analog voltage. Generally, the temperature sensor 10 is classified into a tactile temperature sensor or a non-contact temperature sensor. A tactile temperature sensor comprises most sensors such as a (platinum) resistor temperature sensor, a thermistor, a thermocouple, a bimetal and senses a temperature using a contact with a measurement object. A non-contact temperature sensor comprises a radiation thermometer, or an IC thermometer.

An analog to digital converter 20 converts a temperature value into a temperature code and provides the temperature code to the frequency compensation value provider 30.

A memory unit 40 may comprise a flash memory, a random access memory (RAM), an electrically erasable programmable read only memory (EEPROM). A basic real time operating system and software for call processing are stored in the flash memory, and are operated using variable and status data read-out from the RAM. Here, the ROM, which may be EEPROM, stores non-volatile data which is possible to erase and restore electrically and performs input/output of the non-volatile data by a command of controller 50.

In an embodiment of the present invention, a memory unit 40 stores a program comprising a look up table or an algorithm such as a function for calculating a frequency compensation value to calculate a frequency compensation value for compensating for a frequency error of a system clock resulting from a temperature change. The look up table stores a frequency compensation value of a system clock generated in a DCXO 60 in a table format corresponding to a difference between a predetermined reference temperature and an ambient temperature of a mobile communication terminal.

A frequency compensation value provider 30 calculates a frequency compensation value for compensating for a frequency error of a system clock resulting from a temperature change. That is, a frequency compensation value provider 30 calculates a difference between a temperature value from an A/D converter 20 and a predetermined reference temperature value. Then, the frequency compensation value calculator 30 reads the look up table stored in the memory unit 40, maps a difference into the look up table and finally obtains a frequency error of a system clock generated in the DCXO 60. A frequency compensation value provider 30 provides the frequency error to a controller 50.

A controller 50 controls each of the components of the mobile communication terminal 100. In particular, in an embodiment of the present invention, a controller 50 controls a frequency of the system clock using a control signal for compensating a frequency of a system clock generated in the DCXO 60, an auto frequency control signal, corresponding to a frequency compensation value provided in the frequency compensation value provider 30

A DCXO 60 generates a system clock for the mobile communication terminal 100 according to a control signal by the controller 50. A system clock generated in the DCXO 60 is provided to a controller 50, which is used to synchronize each components of the mobile communication terminal 100 and generates a carrier wave for a modulation and demodulation of a signal.

A wireless transceiver 70 demodulates a wireless signal from an outside through antenna 80, modulates a signal and transmits a modulated signal to the wireless area through antenna 80.

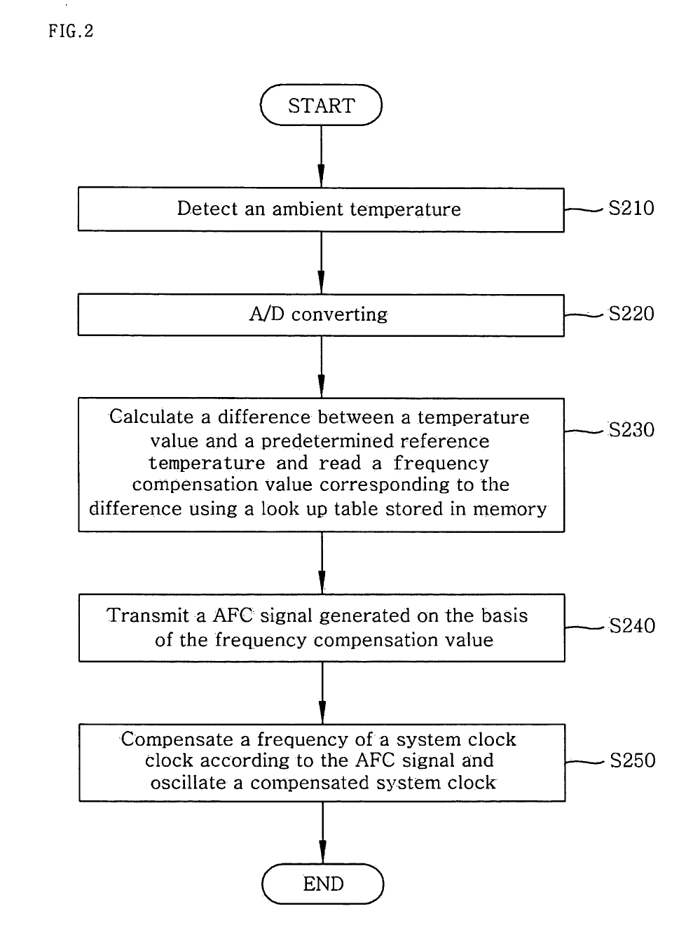

FIG. 2 is a flow chart providing an explanation of a method for compensating the frequency error of system clock in mobile communication terminal with a digitally controlled crystal oscillator according to an embodiment of the present invention.

Referring to FIG. 1 and FIG. 2, a temperature sensor 10 detects an ambient temperature of the mobile communication terminal 100 (S210), an A/D converter 20 converts the detected temperature value to a digital value (S220) and is provided to a frequency compensation value provider 30.

A frequency compensation value provider 30 calculates a difference between an input temperature value and a predetermined reference temperature (ex: 25 degrees at normal temperature), and obtains a frequency compensation value corresponding to a difference using a look up table stored in the memory 40 (S230).

Table 1 represents an example of a look up table which is applied to calculate a frequency error compensation value.

TABLE 1

| Temp_difference | psi_past |
|---|---|
| 0 | 0 [Hz] |
| 1 | 80 [Hz] |
| 2 | 160 [Hz] |
| 3 | 240 [Hz] |
| 4 | 320 [Hz] |
| 5 | 400 [Hz] |
| 6 | 480 [Hz] |
| . . . | . . . |

Referring to Table. 1, Temp_difference represents a difference between a temperature value detected from a temperature sensor 10 and a predetermined reference temperature, and psi_past represents a frequency compensation value for a frequency error of a system clock generated in the DCXO 60.

A process for generating such a lookup table is as follows. Initially, the designer of mobile communication terminal 100 confirms the frequency of system clock, generated from DCXO 60 changing temperature degree by degree which is possible for the mobile communication terminal to operate, for example from −20 degrees to 60 degrees.

Next, the designer of mobile communication terminal 100 compares the confirmed frequency corresponding to the respective temperature with a frequency of a system clock at predetermined reference temperature (ex: 25 degrees at normal temperature), calculates a frequency error corresponding to the respective temperature, tables a calculated value and stores it in memory 40. The lookup table is created through such a process.

Meanwhile, the frequency compensation value provider 30 calculates a difference between temperature value output from the temperature sensor 10 and a predetermined reference value, reads a frequency compensation value of system clock corresponding to a calculated difference in the lookup table. Then, the frequency compensation value provider 30 provides the frequency compensation value to the controller 50.

A controller 50 generates an auto frequency control signal for compensating a frequency of a system clock oscillated in the DCXO 60 on the basis of a frequency compensation value provided in the frequency compensation value provider 30 and transmits it to the DCXO 60 (S240).

DCXO 60 compensates a frequency of a system clock according to an AFC signal that is provided from the controller 50 and oscillates a compensated system clock (S250).

Thus, it is possible to compensate for an oscillation frequency change due to a temperature change in the mobile communication terminal mounting a DCXO.

As described, one embodiment of the present invention discloses that the frequency error of the system clock according to a temperature change is compensated using lookup table.

However, another embodiment discloses that using a frequency compensation value calculation function (ex: y=x(T), wherein y is a frequency compensation value and x(T) is a function depending on a temperature. For this embodiment, the program for executing a frequency compensation calculation function may be stored in memory 40.

Another embodiment of the present invention discloses a frequency compensation value provider 30 which calculates a frequency compensation value using a Taylor series, for example, as described below.

$$f ( freq ) = f ( a ) + {f}^{′} ( a ) ( T - a ) + ( \frac{{f}^{2} ( a )}{2 !} ) {( T - a )}^{2} + ( \frac{{f}^{3} ( a )}{3 !} ) {( T - a )}^{3} + … + ( \frac{{f}^{n} ( a )}{n !} ) {( T - a )}^{n} + …$$

In the above formula, f(freq) is a frequency compensation value, “T” is an ambient temperature detected by a temperature sensor, and “a” is a coefficient according to a characteristic of a DCXO.

Use of the above described Taylor series can accurately predict a frequency error according to a temperature of a DCXO.

Also, in an embodiment of the present invention, a difference is calculated using an A/D converted temperature value and a predetermined reference temperature. However it is possible that a difference between a detected ambient temperature and a predetermined reference temperature may be provided from a temperature sensor.

As described above in an embodiment of the present invention, even if the DCXO, which is less expensive than the TCXO, is mounted on a mobile communication terminal instead of the TCXO which compensates a input signal according to temperature change, it is possible to compensate a oscillation frequency error according to a temperature change.

The foregoing exemplary embodiments and aspects of the invention are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A mobile communication terminal, comprising:
A digitally controlled crystal oscillator for generating a system clock;
A sensor for detecting an ambient temperature;
A frequency compensation value provider for providing a frequency compensation value for compensating for a frequency error in the system clock generated in the digitally controlled crystal oscillator on the basis of the ambient temperature detected from the sensor; and
A controller for transmitting a control signal for compensating for a frequency error of a system clock to the digitally controlled crystal oscillator on the basis of the frequency compensation value provided from the frequency compensation value provider, and for controlling the frequency of the system clock generated from the digitally controlled crystal oscillator.

2. The mobile communication terminal of claim 1, further comprising a memory unit which stores a program for executing a frequency compensation value calculation function to calculate the frequency compensation value, wherein the frequency compensation value provider calculates the frequency compensation value of the system clock using the program when an ambient temperature is input from the sensor.

3. The mobile communication terminal of claim 2, wherein the program calculates the frequency compensation value using a Taylor series as described below:
$$f ( freq ) = f ( a ) + {f}^{′} ( a ) ( T - a ) + ( \frac{{f}^{2} ( a )}{2 !} ) {( T - a )}^{2} + ( \frac{{f}^{3} ( a )}{3 !} ) {( T - a )}^{3} + … + ( \frac{{f}^{n} ( a )}{n !} ) {( T - a )}^{n} + …$$
Wherein the f(freq) is a frequency compensation value, “T” is an ambient temperature detected by a temperature sensor, and “a” is a coefficient according to a characteristic of a DCXO.

4. The mobile communication terminal of claim 1, further comprising a memory unit which stores an ambient temperature and a frequency compensation value of a system clock respectively corresponding to the ambient temperature in the form of a look up table, wherein the frequency compensation value provider reads a frequency compensation value of the system clock corresponding to the ambient temperature by searching the look up table when an ambient temperature is input from the sensor, and outputs the frequency compensation value to controller.

5. The mobile communication terminal of claim 1, further comprising a memory unit which stores a difference between an ambient temperature and predetermined reference temperature, and a frequency compensation value of a system clock respectively corresponding to the difference in the form of a look up table, wherein the frequency compensation value provider calculates a difference between an ambient temperature and a predetermined reference temperature, reads the frequency compensation value of the system clock corresponding to the difference by searching the lookup table, and outputs the frequency compensation value to the controller.

6. The mobile communication terminal of claim 1, further comprising an A/D converter which converts a temperature detected from the sensor to a digital value and provides the digital value to the frequency compensation value provider.

7. A method of compensating a frequency error of a system clock, comprising:
Detecting an ambient temperature;
Providing the frequency compensation value for compensating the frequency error of the system clock which is generated in a digitally controlled crystal oscillator on the basis of the detected ambient temperature; and
Controlling the frequency error of the system clock generated in the digitally controlled crystal oscillator to compensate for the frequency error in accordance with the frequency compensation value.

8. The method of claim 7, further comprising the step of storing a program for executing the frequency compensation value calculation function to calculate the frequency compensation value of the system clock corresponding to the ambient temperature, wherein the frequency compensation value of the system clock is calculated using the program when the ambient temperature is input.

9. The method of claim 8, wherein the program calculates a frequency compensation value using a Taylor series as described below:
$$f ( freq ) = f ( a ) + {f}^{′} ( a ) ( T - a ) + ( \frac{{f}^{2} ( a )}{2 !} ) {( T - a )}^{2} + ( \frac{{f}^{3} ( a )}{3 !} ) {( T - a )}^{3} + … + ( \frac{{f}^{n} ( a )}{n !} ) {( T - a )}^{n} + …$$
Wherein the f(freq) is a frequency compensation value, “T” is an ambient temperature detected by a temperature sensor, and “a” is a coefficient according to a characteristic of a DCXO.

10. The method of claim 7, further comprising the step of storing the ambient temperature and the frequency compensation value of the system clock respectively corresponding to the ambient temperature in the form of lookup table, wherein the frequency compensation value of the system clock corresponding to the ambient temperature is obtained using a lookup table search when the ambient temperature is input.

11. The method of claim 7, further comprising the step of storing a difference between an ambient temperature and a predetermined reference temperature and the frequency compensation value of the system clock respectively corresponding to the difference in the form of a lookup table, wherein the difference between the ambient temperature and the predetermined reference temperature is calculated when the ambient temperature is input, and the frequency compensation value of the system clock corresponding to the difference is obtained using a lookup table search.

12. The method of claim 7, further comprising the step of converting the detected temperature to a digital value.
